(19) United States
(12) Patent Application Publication
(10) Pub. No.: US 2026/0288694 A1
(43) Pub. Date: Sep. 24, 2026

(54) SYSTEM AND METHOD FOR GENERAL PURPOSE PIPELINE FOR QUESTION ANSWERING ON DOCUMENTS

(71) Applicant: JPMorgan Chase Bank, N.A., New York, NY (US)

(72) Inventors: Hanoz BHATHENA, New York, NY (US); Prateek SINGH, Jersey City, NJ (US); Denis KOCHEDYKOV, Brooklyn, NY (US); Kai NI, Basking Ridge, NJ (US); Rohan MITTAL, Jersey City, NJ (US); Souvik DAS, Union City, NJ (US); Kiran NELLORE, Parsippany, NJ (US); Padmini MUNDRA, Fair Lawn, NJ (US); Seetaram RAYARAO, Middletown, DE (US); Nagaraja VARNEKAR, Media, PA (US); Mohan Krishna VANKAYALAPATI, Bournemouth (GB); Krishna UPPALAPATI, Chadds Ford, PA (US); Monica M. HU, New York, NY (US); Birsena AJVAZOVSKA, New York, NY (US); Laura KHOOR, Stamford, CT (US); Marianne GOSMANT, Manhattan, NY (US); Derek WALDRON, New York, NY (US); Dogan BILGUVAR, Basking Ridge, NJ (US); Biswa SENGUPTA, London (GB); Suman Kumar ADDANKI, Chadds Ford, PA (US)

(73) Assignee: JPMorgan Chase Bank, N.A., New York, NY (US)

(21) Appl. No.: 19/573,563

(22) Filed: Mar. 20, 2026

Related U.S. Application Data
(60) Provisional application No. 63/775,017, filed on Mar. 20, 2025.

(51) Int. Cl. G06F 16/22; G06F 40/205; G06F 40/289; G06F 40/30

(52) U.S. Cl. CPC G06F 16/2291; G06F 40/205; G06F 40/289; G06F 40/30

(57) ABSTRACT

Various methods and processes, apparatuses/systems, and media for retrieval-augmented generation (RAG) that enable accurate question answering across multiple domains, including specialized document collections within the financial industry. A general-purpose RAG pipeline is provided that improves upon conventional RAG architectures employing a dense retriever and reader by enhancing end-to-end answer quality, particularly for long-form and complex queries. A processor executes consistent performance gains across a plurality of heterogeneous datasets. Additionally, the processor includes a reference-based evaluation framework in which a large language model operates as an automated judge to assess generated responses against authoritative references, thereby providing a reliable benchmark for evaluating RAG system performance. The processor also addresses limitations of reference-free assessment techniques and enables robust, scalable measurement of retrieval and generation quality in enterprise and financial document environments.

### CROSS-REFERENCE TO RELATED APPLICATIONS

This application claims the benefit of priority from U.S. Provisional Patent Application No. 63/775,017, filed Mar. 20, 2025, which is herein incorporated by reference in its entirety.

### TECHNICAL FIELD

This disclosure generally relates to data processing, and, more particularly, to methods and apparatuses for implementing a platform, language, cloud, database, and domain agnostic general-purpose query-response pipeline module configured for automatic question answering on documents across various domains.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Conventional computer-implemented systems for processing natural-language inputs and generating responses are often based on models trained using static data sets. While these systems can produce coherent outputs, they may exhibit technical limitations in financial or enterprise computing environments, where accurate, current, and context-specific information is critical. Reliance solely on pre-trained data can result in outputs that are outdated, incomplete, or inconsistent with records stored in enterprise databases, regulatory filings, or other domain-specific data sources.

For example, the rise of large language models (LLMs) appears to significantly advance natural language processing, enabling applications like question answering and text generation with remarkable accuracy. However, LLMs often face challenges with factual accuracy, up-to-date knowledge, and context-specific reasoning due to their reliance on static pretraining corpora. To address these limitations, some systems, i.e., Retrieval-Augmented Generation (RAG) systems, may integrate external data retrieval operations into the response generation workflow, allowing the system to dynamically access relevant information from one or more enterprise data sources, such as financial reports, transaction records, regulatory databases, or partner-provided documents. Existing implementations of such retrieval-integrated workflows often involve multiple processing stages with differing execution paths and architectural designs. The lack of a standardized, modular processing architecture may increase technical complexity, reduce efficiency, and hinder reliable deployment across multiple enterprise systems or financial applications.

Accordingly, there exists a technical need for an improved computer-implemented processing pipeline that structures and coordinates query handling, enterprise data retrieval, and response generation.

### SUMMARY

The present disclosure, through one or more of its various aspects, embodiments, and/or specific features or sub-components, provides, among other features, various systems, servers, devices, methods, media, programs, and platforms for implementing a platform, language, cloud, database, and domain agnostic general-purpose query-response pipeline module configured for automatic question answering on documents across various domains, thereby enhancing reliability and accuracy, reducing implementation complexity, and supporting deployment across diverse enterprise computing environments, including financial institutions, corporate reporting systems, and other regulated or high-assurance domains, but the disclosure is not limited thereto.

In some embodiments, a method for implementing a general-purpose question answering (QA) pipeline for question answering on documents across various domains by utilizing one or more processors along with allocated memory is disclosed. The method may include: i) establishing a communication link between a plurality of document sources having various domains and the general-purpose QA pipeline via a communication network, wherein the general-purpose QA pipeline includes an ingestion pipeline and an inference pipeline; ii) receiving, by a receiving module included within the ingestion pipeline, a document among a set of plurality of documents received from the plurality of document sources; iii) chunking, by a chunking module included within the ingestion pipeline, the document into a plurality of chunks each including relatively smaller, semantically meaningful segment to address context length limitations; iv) embedding, by an embedding module included within the ingestion pipeline, the plurality of chunks; v) storing the embedded plurality of chunks into a vector database; repeating steps ii)-v) for all documents among the set of plurality of documents thereby creating a knowledge base; executing the inference pipeline that, given a query, retrieves, by a hybrid retriever module included within the inference pipeline, documents from the knowledge base that are relevant to the query by utilizing weighted combination of sparse and dense retrieval; implementing an LLM-based re-ranker module included within the inference pipeline to re-rank initial candidate chunks from the hybrid retriever module; implementing an LLM-based answer generation module included within the inference pipeline to synthesize information relevant to answering question corresponding to the query from the re-ranked initial candidate chunks; and generating an answer corresponding to the query for consumption by downstream applications.

In some embodiments, in receiving the document, the method may further include: parsing the set of plurality of documents received from the plurality of document sources, wherein the documents having different file formats.

In some embodiments according to the method, the different file formats may include one or more of the following file formats: PDF, .doc, .docx, html, and .txt, but the disclosure is not limited thereto.

In some embodiments, in chunking the document into a plurality of chunks, the method may further include: implementing an LLM to generate a relevant context for each chunk among the plurality of chunks.

In some embodiments according to the method, the vector database may support both the sparse and the dense retrieval.

In some embodiments according to the method, the LLM-based re-ranker module may evaluate relevance by considering both complete and partial information that is useful for answering the query wherein each document is identified by a unique identifier (ID).

In some embodiments, the method may further include: outputting a ranking of the document IDs in a descending order of relevance ensuring that the most relevant documents are prioritized for downstream applications.

In some embodiments, a system for implementing a general-purpose QA pipeline for question answering on documents across various domains is disclosed. The system may include: a processor; and a memory operatively connected to the processor via a communication interface, the memory storing computer readable instructions, when executed, may cause the processor to: i) establish a communication link between a plurality of document sources having various domains and the general-purpose QA pipeline via communication interface, wherein the general-purpose QA pipeline includes an ingestion pipeline and an inference pipeline; ii) receive, via a receiving module included within the ingestion pipeline, a document among a set of plurality of documents received from the plurality of document sources; iii) chunk, via a chunking module included within the ingestion pipeline, the document into a plurality of chunks each including relatively smaller, semantically meaningful segment to address context length limitations; iv) embed, via an embedding module included within the ingestion pipeline, the plurality of chunks; v) store the embedded plurality of chunks into a vector database; repeat steps ii)-v) for all documents among the set of plurality of documents thereby creating a knowledge base; execute the inference pipeline that, given a query, retrieves, by a hybrid retriever module included within the inference pipeline, documents from the knowledge base that are relevant to the query by utilizing weighted combination of sparse and dense retrieval; implement an LLM-based re-ranker module included within the inference pipeline to re-rank initial candidate chunks from the hybrid retriever module; implement an LLM-based answer generation module included within the inference pipeline to synthesize information relevant to answering question corresponding to the query from the re-ranked initial candidate chunks; and generate an answer corresponding to the query for consumption by downstream applications.

In some embodiments, in receiving the document, the processor may be further configured to: parse the set of plurality of documents received from the plurality of document sources, wherein the documents having different file formats.

In some embodiments according to the system, the different file formats may include one or more of the following file formats: PDF, .doc, .docx, html, and .txt, but the disclosure is not limited thereto.

In some embodiments, in chunking the document into a plurality of chunks, the processor may be further configured to: implement an LLM to generate a relevant context for each chunk among the plurality of chunks.

In some embodiments according to the system, the vector database may support both the sparse and the dense retrieval.

In some embodiments according to the system, the LLM-based re-ranker module may evaluate relevance by considering both complete and partial information that is useful for answering the query wherein each document is identified by an ID.

In some embodiments, the processor may be further configured to: output a ranking of the document IDs in a descending order of relevance ensuring that the most relevant documents are prioritized for downstream applications.

In some embodiments, a non-transitory computer readable medium configured to store instructions for implementing a general-purpose QA pipeline for question answering on documents across various domains is disclosed. The instructions, when executed, may cause a processor to perform the following: i) establishing a communication link between a plurality of document sources having various domains and the general-purpose QA pipeline via a communication network, wherein the general-purpose QA pipeline includes an ingestion pipeline and an inference pipeline; ii) receiving, by a receiving module included within the ingestion pipeline, a document among a set of plurality of documents received from the plurality of document sources; iii) chunking, by a chunking module included within the ingestion pipeline, the document into a plurality of chunks each including relatively smaller, semantically meaningful segment to address context length limitations; iv) embedding, by an embedding module included within the ingestion pipeline, the plurality of chunks; v) storing the embedded plurality of chunks into a vector database; repeating steps ii)-v) for all documents among the set of plurality of documents thereby creating a knowledge base; executing the inference pipeline that, given a query, retrieves, by a hybrid retriever module included within the inference pipeline, documents from the knowledge base that are relevant to the query by utilizing weighted combination of sparse and dense retrieval; implementing an LLM-based re-ranker included within the inference pipeline to re-rank initial candidate chunks from the hybrid retriever module; implementing an LLM-based answer generation module included within the inference pipeline to synthesize information relevant to answering question corresponding to the query from the re-ranked initial candidate chunks; and generating an answer corresponding to the query for consumption by downstream applications.

In some embodiments, in receiving the document, the instructions, when executed, may cause the processor to further perform the following: parsing the set of plurality of documents received from the plurality of document sources, wherein the documents having different file formats.

In some embodiments according to the non-transitory computer readable medium, the different file formats may include one or more of the following file formats: PDF, .doc, .docx, html, and .txt, but the disclosure is not limited thereto.

In some embodiments, in chunking the document into a plurality of chunks, the instructions, when executed, may cause the processor to further perform the following: implementing an LLM to generate a relevant context for each chunk among the plurality of chunks.

In some embodiments according to the non-transitory computer readable medium, the vector database may support both the sparse and the dense retrieval.

In some embodiments according to the non-transitory computer readable medium, the LLM-based re-ranker module may evaluate relevance by considering both complete and partial information that is useful for answering the query wherein each document is identified by an ID.

In some embodiments, the instructions, when executed, may cause the processor to further perform the following: outputting a ranking of the document IDs in a descending order of relevance ensuring that the most relevant documents are prioritized for downstream applications.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, cloud, database, and domain agnostic general-purpose query-response pipeline module configured for automatic question answering on documents across various domains in accordance with an embodiment.

FIG. 2 illustrates a diagram of a network environment with a platform, language, cloud, database, and domain agnostic general-purpose query-response pipeline device in accordance with an embodiment.

FIG. 3 illustrates a system diagram for implementing a platform, language, cloud, database, and domain agnostic general-purpose query-response pipeline device having a platform, language, cloud, database, and domain agnostic query-response pipeline module in accordance with an embodiment.

FIG. 4 illustrates a system diagram for implementing a platform, language, cloud, database, and domain agnostic general-purpose query-response pipeline module of FIG. 3 in accordance with an embodiment.

FIG. 5 illustrates a flow chart of a process implemented by the platform, language, cloud, database, and domain agnostic general-purpose query-response pipeline module of FIG. 4 configured for automatic question answering on documents across various domains in accordance with an embodiment.

FIG. 6 illustrates an architecture that includes an ingestion pipeline implemented by the platform, language, cloud, database, and domain agnostic general-purpose query-response pipeline module of FIG. 4 in accordance with an embodiment.

FIG. 7 illustrates an inference pipeline implemented by the platform, language, cloud, database, and domain agnostic general-purpose query-response pipeline module of FIG. 4 in accordance with an embodiment.

FIG. 8 illustrates an architecture of a synthetic dataset generation pipeline implemented by the platform, language, cloud, database, and domain agnostic general-purpose query-response pipeline module of FIG. 4 in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in may include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art may appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

As mentioned earlier, conventional computer-implemented systems for processing natural-language inputs and generating responses are typically trained on static data sets. While capable of producing linguistically coherent outputs, such systems often exhibit technical limitations in financial and enterprise environments, where accuracy, timeliness, and context-specific information are critical. Reliance on pre-trained data alone may result in outputs that are outdated, incomplete, or inconsistent with enterprise records, financial reports, regulatory filings, or other domain-specific data sources.

To address these limitations, some systems integrate external data retrieval into the response generation workflow, enabling dynamic access to relevant enterprise data during query processing. However, existing workflows often involve multiple, loosely coordinated processing stages with varying execution paths, resulting in increased technical complexity, reduced efficiency, reduced data processing capabilities, and limited portability across enterprise systems. Accordingly, there is a technical need for an improved computer-implemented processing pipeline that coordinates query handling, data retrieval, and response generation in a modular and structured manner, enhancing reliability, accuracy, and efficiency in financial and regulated computing environments.

The general-purpose query-response pipeline module as disclosed herein may be configured for automatically processing a wide range of user queries and generating accurate and comprehensive responses based on information contained within one or more structured or unstructured document corpora, referred to as knowledge bases (KBs). By utilizing the general-purpose query-response pipeline module as disclosed herein, a user may submit an arbitrary question, and the general-purpose query-response pipeline module may identify relevant content within the selected knowledge base to produce a response that accurately reflects the information stored in the KB. The general-purpose query-response pipeline module as disclosed herein may be designed to handle diverse query types and content domains, ensuring reliability and completeness of the responses without being restricted to predefined question templates or specific document formats.

In addition, the general-purpose query-response pipeline module as disclosed herein may be configured for simultaneous multi-KB operation, where multiple knowledge bases may be accessible at runtime. Upon receiving a user query, the general-purpose query-response pipeline module as disclosed herein may automatically determines which KB—or combination of KBs—is most appropriate for answering the question. The general-purpose query-response pipeline module may then retrieve and process relevant information from the selected KB(s) to generate a response. This capability allows the general-purpose query-response pipeline module to dynamically select among multiple data sources, ensuring that answers are drawn from the most relevant and authoritative information available. Such a design enhances the flexibility and applicability of the system across diverse enterprise or domain-specific environments, including financial, regulatory, or corporate knowledge repositories, where accurate, up-to-date, and contextually appropriate responses are critical.

Although the financial domain is used herein as an illustrative example, the disclosed invention is not limited to financial applications. The systems and methods described herein may be applied to a wide range of other domains that require accurate, context-sensitive, and comprehensive question answering from one or more knowledge bases. Such domains may include, but are not limited to, healthcare, legal, scientific research, technical support, corporate reporting, regulatory compliance, and enterprise knowledge management. The disclosed invention may be capable of dynamically accessing, retrieving, and processing information from relevant document corpora in any domain, without departing from the scope of the present disclosure. In this manner, the disclosed invention provides a flexible and general-purpose framework for improving the reliability, accuracy, and efficiency of automated information retrieval and response generation across diverse technical and business environments.

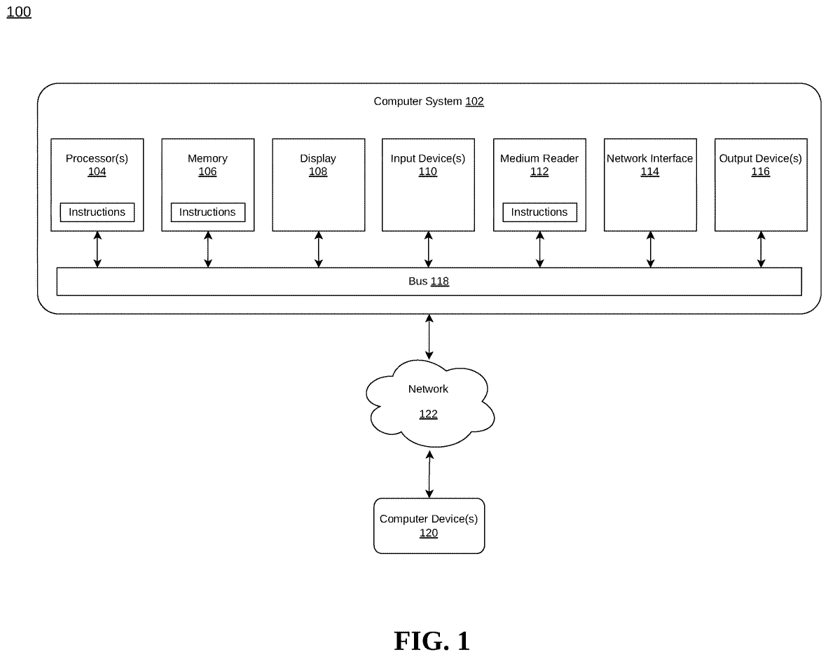

FIG. 1 is an exemplary system 100 for use in implementing the platform, language, cloud, database, and domain agnostic general-purpose query-response pipeline module configured for automatic question answering on documents across various domains, thereby enhancing reliability and accuracy, reducing implementation complexity, and supporting deployment across diverse enterprise computing environments, including financial institutions, corporate reporting systems, and other regulated or high-assurance domains in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. In some embodiments, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 may be tangible and non-transitory. As used herein, the term “non-transitory” is to be interpreted not as an eternal characteristic of a state, but as a characteristic of a state that may last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data and executable instructions, and are non-transitory during the time instructions are stored therein. Again, as used herein, the term “non-transitory” is to be interpreted not as an eternal characteristic of a state, but as a characteristic of a state that may last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, in some embodiments, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. In some embodiments, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the query-response pipeline module may be platform, language, cloud, database, and domain agnostic that may allow for consistent easy orchestration and passing of data through various components of the general-purpose query-response pipeline module to output a desired result, i.e., answers, mapping updates, events, and polices, etc., regardless of platform, browser, language, database, and cloud environment enabling interoperability across heterogeneous sector-specific protocols. Since the disclosed process, in some embodiments, may be platform, language, database, browser, and cloud agnostic, the general-purpose query-response pipeline module may be independently tuned or modified for optimal performance without affecting the configuration or data files providing real-time, compliance-aware interoperability across the heterogeneous industry domains. The configuration or data files, in some embodiments, may be written using JSON, but the disclosure is not limited thereto. In some embodiments, the configuration or data files may easily be extended to other readable file formats such as XML, YAML, etc., or any other configuration-based languages.

In accordance with various embodiments of the present disclosure, the methods described herein may be implemented using a hardware computer system that executes software programs. Further, in an exemplary, non-limited embodiment, implementations may include distributed processing, component/object distributed processing, and an operation mode having parallel processing capabilities. Virtual computer system processing may be constructed to implement one or more of the methods or functionality as described herein, and a processor described herein may be used to support a virtual processing environment.

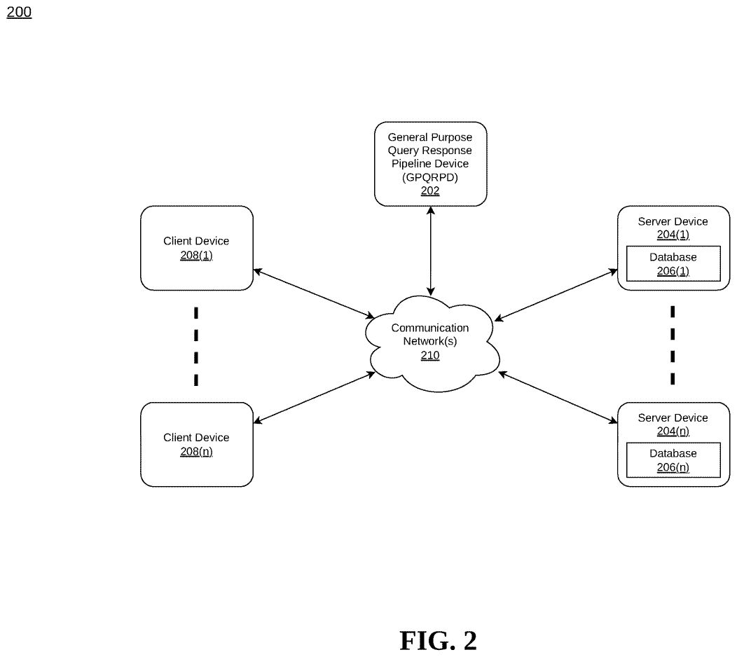

Referring to FIG. 2, a schematic of an exemplary network environment 200 for implementing a language, platform, database, and cloud agnostic general-purpose query-response pipeline device (GPQRPD) of the instant disclosure is illustrated.

In some embodiments, the above-described problems associated with conventional tools may be overcome by implementing an GPQRPD 202 as illustrated in FIG. 2 that may be configured for implementing a platform, language, cloud, database, and domain agnostic general-purpose query-response pipeline module configured for automatic question answering on documents across various domains, thereby enhancing reliability and accuracy, reducing implementation complexity, and supporting deployment across diverse enterprise computing environments, including financial institutions, corporate reporting systems, and other regulated or high-assurance domains, but the disclosure is not limited thereto.

The GPQRPD 202 may have one or more computer system 102s, as described with respect to FIG. 1, which in aggregate provide the necessary functions.

The GPQRPD 202 may store one or more applications that may include executable instructions that, when executed by the GPQRPD 202, cause the GPQRPD 202 to perform actions, such as to transmit, receive, or otherwise process network messages, in some embodiments, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the GPQRPD 202 itself, may be located in virtual server(s) running in a cloud-based computing environment rather than being tied to one or more specific physical network computing devices. Also, the application(s) may be running in one or more virtual machines (VMs) executing on the GPQRPD 202. Additionally, in one or more embodiments of this technology, virtual machine(s) running on the GPQRPD 202 may be managed or supervised by a hypervisor.

In the network environment 200 of FIG. 2, the GPQRPD 202 may be coupled to a plurality of server devices 204(1)-204(n) that hosts a plurality of databases 206(1)-206(n), and also to a plurality of client devices 208(1)-208(n) via communication network(s) 210. A communication interface of the GPQRPD 202, such as the network interface 114 of the computer system 102 of FIG. 1, operatively couples and communicates between the GPQRPD 202, the server devices 204(1)-204(n), and/or the client devices 208(1)-208(n), which may all be coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the GPQRPD 202, the server devices 204(1)-204(n), and/or the client devices 208(1)-208(n) may be coupled together via other topologies. Additionally, the network environment 200 may include other network devices such as one or more routers and/or switches, in some embodiments, which are well known in the art and thus may not be described herein.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, in some embodiments, teletraffic in any suitable form (e.g., voice, modem, and the like), Public Switched Telephone Network (PSTNs), Ethernet-based Packet Data Networks (PDNs), combinations thereof, and the like.

The GPQRPD 202 may be a standalone device or integrated with one or more other devices or apparatuses, such as one or more of the server devices 204(1)-204(n). In some embodiments, the GPQRPD 202 may be hosted by one of the server devices 204(1)-204(n), and other arrangements may also be possible. Moreover, one or more of the devices of the GPQRPD 202 may be in the same or a different communication network including one or more public, private, or cloud networks, in some embodiments.

The plurality of server devices 204(1)-204(n) may be the same or similar to the computer system 102 or the computer device 120 as described with respect to FIG. 1, including any features or combination of features described with respect thereto. In some embodiments, any of the server devices 204(1)-204(n) may include, among other features, one or more processors, a memory, and a communication interface, which may be coupled together by a bus or other communication link, although other numbers and/or types of network devices may be used. The server devices 204(1)-204(n) in this example may process requests received from the GPQRPD 202 via the communication network(s) 210 according to the HTTP-based and/or JSON protocol, in some embodiments, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that may be configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

In some embodiments, the server devices 204(1)-204(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures may also be envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that may facilitate the implementation of the GPQRPD 202 that may efficiently provide a platform for implementing a platform, language, cloud, database, and domain agnostic general-purpose query-response pipeline module configured for automatic question answering on documents across various domains, thereby enhancing reliability and accuracy, reducing implementation complexity, and supporting deployment across diverse enterprise computing environments, including financial institutions, corporate reporting systems, and other regulated or high-assurance domains, but the disclosure is not limited thereto.

The client devices 208(1)-208(n) may run interface applications, such as standard web browsers or standalone client applications, which may provide an interface to communicate with the GPQRPD 202 via the communication network(s) 210 in order to communicate user requests. The client devices 208(1)-208(n) may further include, among other features, a display device, such as a display screen or touchscreen, and/or an input device, such as a keyboard, in some embodiments.

Although the exemplary network environment 200 with the GPQRPD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the GPQRPD 202, the server devices 204(1)-204(n), or the client devices 208(1)-208(n), in some embodiments, may be configured to operate as virtual instances on the same physical machine. In some embodiments, one or more of the GPQRPD 202, the server devices 204(1)-204(n), or the client devices 208(1)-208(n) may operate on the same physical device rather than as separate devices communicating through communication network(s) 210. Additionally, there may be more or fewer GPQRPDs 202, server devices 204(1)-204(n), or client devices 208(1)-208(n) than illustrated in FIG. 2. In some embodiments, the GPQRPD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

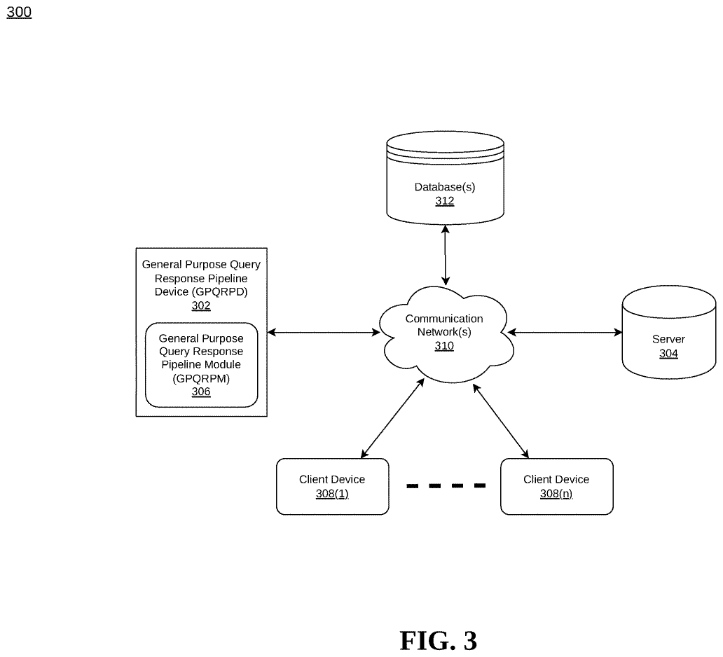

FIG. 3 illustrates a system diagram for implementing a platform, language, and cloud agnostic GPQRPD having a platform, language, cloud, database, and domain agnostic general-purpose query-response pipeline module (GPQRPM) in accordance with an embodiment.

As illustrated in FIG. 3, the system 300 may include an GPQRPD 302 within which an GPQRPM 306 may be embedded, a server 304, a database(s) 312, a plurality of client devices 308(1) . . . 308(n), and a communication network 310.

In some embodiments, the GPQRPD 302 including the GPQRPM 306 may be connected to the server 304, and the database(s) 312 via the communication network 310. The GPQRPD 302 may also be connected to the plurality of client devices 308(1) . . . 308(n) via the communication network 310, but the disclosure is not limited thereto.

According to an exemplary embodiment, the GPQRPD 302 is described and shown in FIG. 3 as including the GPQRPM 306, although it may include other rules, policies, modules, databases, or applications, etc. In some embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In some embodiments, the database(s) 312 may store a bias dictionary within the scope of the present disclosure as disclosed herein.

In some embodiments, the GPQRPM 306 may be configured to receive real-time feed of data from the plurality of client devices 308(1) . . . 308(n) and secondary sources via the communication network 310.

As may be described below, the GPQRPM 306 may be configured to: i) establish a communication link between a plurality of document sources having various domains and the general-purpose QA pipeline via communication interface, wherein the general-purpose QA pipeline includes an ingestion pipeline and an inference pipeline; ii) receive, via a receiving module included within the ingestion pipeline, a document among a set of plurality of documents received from the plurality of document sources; iii) chunk, via a chunking module included within the ingestion pipeline, the document into a plurality of chunks each including relatively smaller, semantically meaningful segment to address context length limitations; iv) embed, via an embedding module included within the ingestion pipeline, the plurality of chunks; v) store the embedded plurality of chunks into a vector database; repeat steps ii)-v) for all documents among the set of plurality of documents thereby creating a knowledge base; execute the inference pipeline that, given a query, retrieves, by a hybrid retriever module included within the inference pipeline, documents from the knowledge base that are relevant to the query by utilizing weighted combination of sparse and dense retrieval; implement an LLM-based re-ranker included within the inference pipeline to re-rank initial candidate chunks from the hybrid retriever module; implement an LLM-based answer generation module included within the inference pipeline to synthesize information relevant to answering question corresponding to the query from the re-ranked initial candidate chunks; and generate an answer corresponding to the query for consumption by downstream applications, but the disclosure is not limited thereto.

The plurality of client devices 308(1) . . . 308(n) are illustrated as being in communication with the GPQRPD 302. In this regard, the plurality of client devices 308(1) . . . 308(n) may be “clients” (e.g., customers) of the GPQRPD 302 and are described herein as such. Nevertheless, it is to be known and understood that the plurality of client devices 308(1) . . . 308(n) need not necessarily be “clients” of the GPQRPD 302, or any entity described in association therewith herein. Any additional or alternative relationship may exist between either or both of the plurality of client devices 308(1) . . . 308(n) and the GPQRPD 302, or no relationship may exist.

The first client device 308(1) may be, in some embodiments, a smart phone. Of course, the first client device 308(1) may be any additional device described herein. The second client device 308(n) may be, in some embodiments, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. In an embodiment, one or more of the plurality of client devices 308(1) . . . 308(n) may communicate with the GPQRPD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The GPQRPD 302 may be the same or similar to the GPQRPD 202 as described with respect to FIG. 2, including any features or combination of features described with respect thereto.

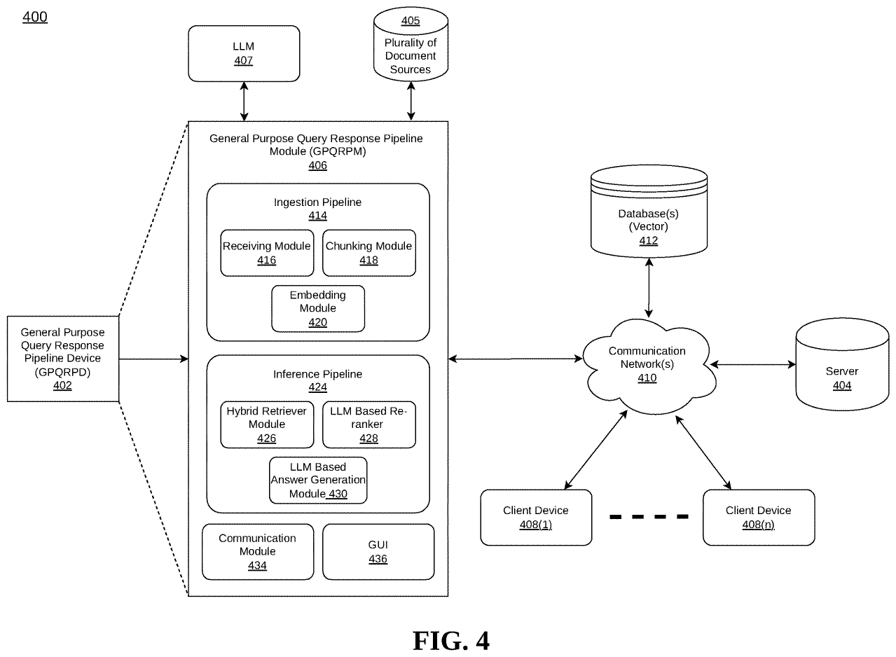

FIG. 4 illustrates a system diagram for implementing a platform, language, cloud, database, and domain agnostic GPQRPM of FIG. 3 in accordance with an exemplary embodiment.

In some embodiments, the system 400 may include a platform, language, cloud, database, and domain agnostic GPQRPD 402 within which a platform, language, cloud, database, and domain agnostic GPQRPM 406 may be embedded, a server 404, a plurality of document sources 405, an LLM 407, and a database(s) 412 (i.e., vector database). In some embodiments, the server 404 may comprise a plurality of servers located centrally or located in different locations, but the disclosure is not limited thereto.

In some embodiments, the GPQRPD 402 including the GPQRPM 406 may be connected to the server 404, the plurality of document sources 405, the LLM 407, and the database(s) 412, via the communication network 410 and communication module/network interface. The GPQRPD 402 may also be connected to the plurality of client devices 408(1)-408(n) via the communication network 410, but the disclosure is not limited thereto. The GPQRPM 406, the server 404, the plurality of client devices 408(1)-408(n), the database(s) 412, and the communication network 410 as illustrated in FIG. 4 may be the same or similar configuration to the GPQRPM 306, the server 304, the plurality of client devices 308(1)-308(n), the database(s) 312, the communication network 310, respectively, as illustrated in FIG. 3.

In some embodiments, as illustrated in FIG. 4, the GPQRPM 406 may include an ingestion pipeline 414, an inference pipeline 424, a communication module 434, and a Graphical User Interface (GUI) 436. The ingestion pipeline 414 may include a receiving module 416, a chunking module 418, and an embedding module 420 that may also be referred to as an embedding model. The inference pipeline 424 may include a hybrid retriever module 426, an LLM based re-ranker 428, and an LLM based answer generation module 430 that may also be referred to as a reader or an answer generator. In some embodiments, interactions and data exchange among these modules included in the GPQRPM 406 provide the advantageous effects of the disclosed invention. Functionalities of each module of FIG. 4 may be described in detail below with reference to FIGS. 4-8.

In some embodiments, each of the receiving module 416, chunking module 418, embedding module 420, a hybrid retriever module 426, an LLM based re-ranker 428, an LLM based answer generation module 430, and the communication module 434 of the GPQRPM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

In some embodiments, each of the receiving module 416, chunking module 418, embedding module 420, a hybrid retriever module 426, an LLM based re-ranker 428, an LLM based answer generation module 430, and the communication module 434 of the GPQRPM 406 of FIG. 4 may be implemented by microprocessors or similar, and may be programmed using software (e.g., microcode) to perform various functions discussed herein and may optionally be driven by firmware and/or software.

Alternatively, in some embodiments, each of the receiving module 416, chunking module 418, embedding module 420, a hybrid retriever module 426, an LLM based re-ranker 428, an LLM based answer generation module 430, and the communication module 434 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. In some embodiments, the GPQRPM 406 of FIG. 4 may also be implemented by cloud-based deployment.

In some embodiments, each of the receiving module 416, chunking module 418, embedding module 420, a hybrid retriever module 426, an LLM based re-ranker 428, an LLM based answer generation module 430, and the communication module 434 of the GPQRPM 406 of FIG. 4 may be called via corresponding API, but the disclosure is not limited thereto. For example, in some embodiments, the receiving module 416 may be called via a first API, the chunking module 418 may be called via a second API, the embedding module 420 may be called via a third API, the hybrid retriever module 426 may be called via a fourth API, the LLM based re-ranker module 428 may be called via a fifth API, the LLM based answer generation module 430 may be called via a sixth API, and the communication module 434 may be called via a seventh API. In some embodiments, calls may also be made using event-based message interfaces in addition to APIs. An event-based message interface may be a design pattern that enables communication between services by defining events and handlers that process them. This approach may allow for efficient communication and decoupled components, which may lead to more flexible and modular systems.

As mentioned, conventional computer-implemented natural language processing systems for generating responses to user queries are commonly implemented using pre-trained language models that rely primarily on static training data. Although such systems may generate grammatically coherent text, they exhibit technical limitations in enterprise, financial, and regulated computing environments, where response correctness, temporal validity, and grounding in authoritative data sources are critical. In particular, responses generated solely from model parameters, without runtime retrieval, may be outdated, incomplete, or inconsistent with enterprise databases, financial records, regulatory filings, or other domain-specific repositories.

To address these deficiencies, certain systems incorporate RAG techniques in which external data sources are queried during inference and retrieved content is provided to a language model for response generation. However, existing RAG workflows often employ fragmented or loosely integrated pipelines in which query parsing, document retrieval, context assembly, and response generation are executed through disparate components with non-deterministic execution paths. Such architectures increase system complexity, reduce inference efficiency, constrain scalability, and impair portability across enterprise computing environments. Accordingly, a technical need exists for an improved computer-implemented RAG pipeline that structurally integrates query processing, retrieval operations, context grounding, and generative response synthesis in a modular and coordinated manner, thereby improving reliability, accuracy, and computational efficiency in financial and regulated domains.

The GPQRPM 406 as disclosed herein may be configured to automatically process natural-language queries and to generate grounded responses using retrieved context from one or more structured and/or unstructured document corpora, herein referred to as knowledge bases (KBs). In operation, a query may be received and processed to generate a retrieval representation, which may be used to identify and retrieve relevant content from a selected KB. The retrieved content may be then incorporated as contextual input to a response generation component, such as the LLM 407, to produce an output that reflects and may be constrained by the retrieved information. The disclosed RAG pipeline implemented by the GPQRPM 406 module may support diverse query types and content domains without reliance on predefined question templates or fixed document formats, thereby enabling robust and accurate response generation across heterogeneous data sources.

In some embodiments, the GPQRPM 406 may be further configured for simultaneous access to a plurality of knowledge bases at runtime. Upon receipt of a query, the GPQRPM 406 may automatically determine, based on relevance scoring, metadata, or contextual signals, which knowledge base or combination of knowledge bases is most appropriate for retrieval. Retrieved content from the selected knowledge base(s) may be then aggregated and provided to the response generation component to produce a unified, grounded response. This multi-knowledge-base RAG configuration enables dynamic source selection and authoritative grounding, thereby improving response accuracy, adaptability, and applicability in enterprise, financial, regulatory, and compliance-driven environments.

In some embodiments, the process implemented by the GPQRPM 406 may be executed via the communication module 434, and the communication network 410, which may comprise plural networks as described above. In some embodiments, in an exemplary embodiment, the various components of the GPQRPM 406 may communicate with the server 404, the plurality of documents sources 405, the LLM 407, and the database(s) 412 via the communication module 434 and the communication network 410 and the results (i.e., answers) may be displayed onto the GUI 436. Of course, these embodiments are merely exemplary and are not limiting or exhaustive. The database(s) 412 may include the databases included within the private cloud and/or public cloud and the server 404 may include one or more servers within the private cloud and the public cloud.

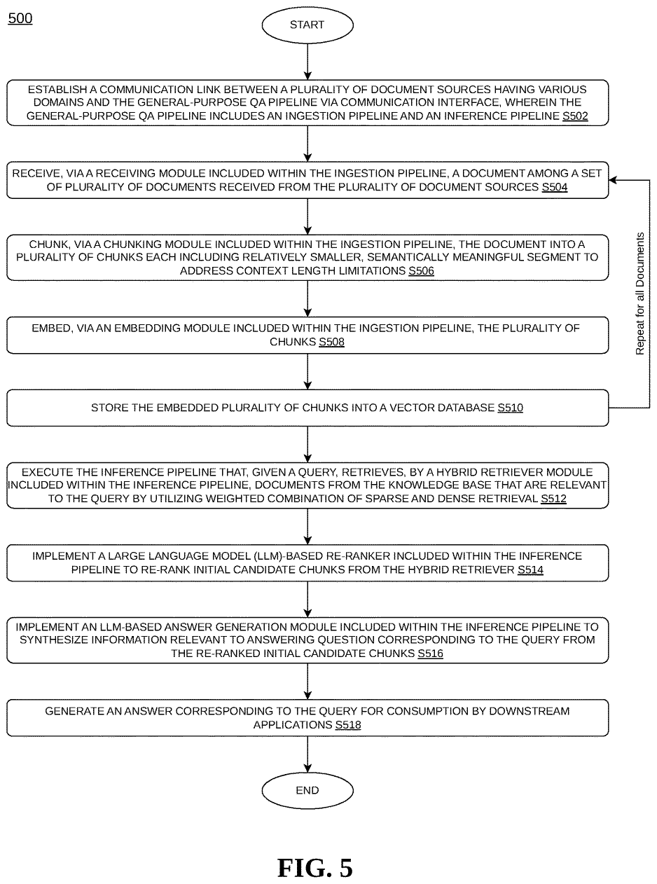

The interactions among the components of the GPQRPM 406 of FIG. 4 corresponding to FIGS. 4-5 are disclosed below. FIG. 5 illustrates a flow chart of a process 500 implemented by the platform, language, cloud, database, and domain agnostic GPQRPM 406 of FIG. 4 for automatic question answering on documents across various domains in accordance with an embodiment. It may be appreciated that the illustrated process 500 and associated steps may be performed in a different order, with illustrated steps omitted, with additional steps added, or with a combination of reordered, combined, omitted, or additional steps.

In some embodiments, at step S502, the process 500 implemented by the GPQRPM 406 may include establishing a communication link, by calling the communication module 434 via the seventh API, between the plurality of document sources 405 having various domains and a general-purpose QA pipeline (GPQRPM 406 may also be referred to as a general-purpose QA pipeline without departing from the scope of the present disclosure) via the communication network 410. The general-purpose QA pipeline includes the ingestion pipeline 414 and the inference pipeline 424.

In some embodiments, at step S504, the process 500 implemented by the GPQRPM 406 may include receiving, by calling the receiving module 416 included within the ingestion pipeline 414 via the first API, a document among a set of plurality of documents received from the plurality of document sources 405. In receiving the document, at step S504 of the process 500 may further include parsing the set of plurality of documents received from the plurality of document sources 405, wherein the documents having different file formats. The different file formats may include one or more of the following file formats: PDF, .doc, .docx, html, and .txt, but the disclosure is not limited thereto.

In some embodiments, at step S506, the process 500 implemented by the GPQRPM 406 may include chunking, by calling the chunking module 418 included within the ingestion pipeline 414 via the second API, the document into a plurality of chunks each including relatively smaller, semantically meaningful segment to address context length limitations. In some embodiments, in chunking the document into a plurality of chunks, at step S506 of the process 500 may further include implementing the LLM 407 to generate a relevant context for each chunk among the plurality of chunks.

In some embodiments, chunking divides large documents into smaller, semantically meaningful segments. It appears necessary for commercial scale RAG pipelines, both in retrieval embedding models and answer generating LLMs due to context length limitations in both, particularly in the former. In some embodiments, the chunking module 418 may utilize a soft token-length based chunking scheme, with a fixed maximum upper bound. To prevent context fragmentation, it is ensured that sentence boundaries were preserved, avoiding the splitting of sentences across successive chunks thereby making every chunk a semantically meaningful unit.

In some embodiments, to account for sentence (and word) tokenization failures, rare but not impossible, the GPQRPM 406 may build a two-stage fallback based on hard word and character count based chunking. Additionally, the GPQRPM 406 may explore the use of chunk overlap, where overlapping chunks help preserve context across segments.

A use case scenario included experimenting with a 10% word overlap between chunks which resulted in a small improvement in end-to-end performance. Selecting an appropriate chunk size may prove to be crucial for achieving optimal retrieval quality. An unsuitable chunk size may cause a retriever model implemented by the GPQRPM 406 to struggle with segments that are noisy, incomplete, or excessively large.

In some embodiments, experiments were conducted with chunk sizes ranging from 200 to 1000 words, observing that the performance of the GPQRPM 406 reaches its peak at an optimal chunk 125 size before declining. Going forward in the rest of the paper chunks and documents may be referred to interchangeably, i.e. when one references retrieved documents, they actually are the retrieved chunks.

For commercial scale QA systems, chunking is an indispensable part of any industrial RAG system. However, when the chunking module 418 chunks documents, one may lose global information about a document and typically a knowledge base underlying RAG may have several thousands or millions of documents. To retrieve the best chunk, the chunking module 418 may not only need the localized information present in the content of the chunk, but also need some document level global information.

Conventional contextual chunking may be quite computationally heavy. Thus, the chunking module 418 as disclosed herein may implement “file name in chunk” algorithm and “LLM generated short description.” In file name in chunk algorithm, the chunking module 418 may be configured to prefix the chunk with the file name of the document. This might not always be optimal as one may not always name their files descriptively, sometimes even giving numbers or hashes as names.

In LLM generated short description algorithm, the chunking module 418 may be configured to look at the first N pages (or tokens) of a document and ask an LLM (i.e., the LLM 407) to generate a short description. This descriptor may be prefixed to every chunk of the document.

Contextual chunking is an advanced technique designed to enhance document chunking for improved retrieval performance. Traditional methods often struggle with providing optimal global context for each chunk which would help with accurate retrieval. Instead of appending a file description or summary to each chunk, which may lack specificity especially for very large documents, contextual chunking uses a LLM to generate a relevant context for each chunk. Therefore, the global text which is appended is chunk specific unlike a file summary.

In some embodiments, at step S508, the process 500 implemented by the GPQRPM 406 may include embedding, by calling the embedding module 420 included within the ingestion pipeline 414 via the third API, the plurality of chunks.

In some embodiments, at step S510, the process 500 implemented by the GPQRPM 406 may include storing the embedded plurality of chunks into a vector database, i.e., the database(s) 412. Sequentially repeating steps S504, S506, S508, and S510 for all documents among the set of plurality of documents thereby creating a knowledge base. The vector database may support both the sparse and the dense retrieval.

During inference time execution of a RAG pipeline, given a query, the GPQRPM 406 may first retrieve the relevant documents from the knowledge base. The retrieval process may be performed using the following classes of methods: sparse retrieval, dense retrieval, and hybrid retrieval.

For sparse retrieval method, the GPQRPM 406 may implement BM25 (BM is an abbreviation of best matching) (specifically Okapi BM25) algorithm is a classical sparse retrieval algorithm used to rank documents based on how well they match a query using term frequency statistics, rather than embeddings. In an RAG system, BM25 may be commonly used as a sparse retriever that complements dense or neural retrieval. BM25 is a probabilistic information retrieval algorithm that scores documents based on: exact keyword overlap between a query and a document; term importance (how frequently a term appears in a document and across the corpus); and document length normalization (to avoid favoring long documents). Unlike dense retrieval, BM25 does not rely on vector embeddings or neural models. Instead, it operates over an inverted index built from the document corpus.

Dense retrieval algorithm is performed by calculating the query embedding with a dense retrieval model and retrieving the top-k documents based on the maximum cosine similarity between the query and document embedding.

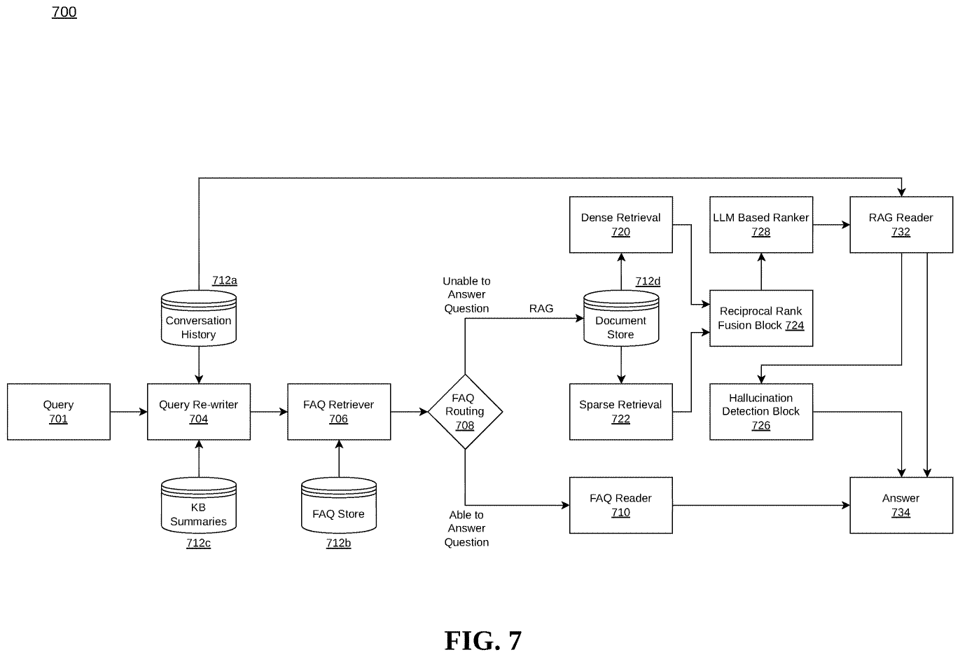

Hybrid retrieval algorithm combines the benefits of sparse and dense retrieval methods by retrieving results from both a sparse and a dense retriever and combining them using reciprocal rank fusion (RRF) (see, e.g., reciprocal rank fusion block 724 as disclosed below with reference to FIG. 7).

In some embodiments, the GPQRPM 406 of FIG. 4 may utilize a top-k of 30 documents (chunks) at the end of retrieval stage. For the hybrid retrieval, the GPQRPM 406 of FIG. 4 may retrieve 70 chunks using the dense retriever, 100 chunks using the sparse retriever, combine them using RRF and select the top-30 chunks from the combined set as the output to the next i.e., re-ranking stage.

In some embodiments, at step S512, the process 500 implemented by the GPQRPM 406 may include executing the inference pipeline 424 that, given a query, retrieves, by a hybrid retriever module 426, called via the fourth API, included within the inference pipeline 424, documents from the knowledge base that are relevant to the query by utilizing weighted combination of sparse and dense retrieval.

In some embodiments, at step S514, the process 500 implemented by the GPQRPM 406 may include implementing the LLM-based re-ranker 428, called via the fifth API, included within the inference pipeline 424 to re-rank initial candidate chunks from the hybrid retriever module 426. In some embodiments, two approaches for re-ranking may be implemented by the re-ranker module 428. The first approach may utilize a cross-encoding method, implemented using a sentence transformers library. Cross-encoders, take in (query, document) pairs and output a score which is then used to re-rank the retrieved sources. The second approach may be inspired by the success of large language models (LLMs) as re-ranking agents. This generative approach focuses on list-wise (also called permutation generation) relevance re-ranking. The relevance re-ranker may be designed to reorder documents based on their relevance to a specific query. It accepts a query, along with a list of documents from an upstream retriever, where each document is identified by a unique ID. The LLM-based re-ranker 428 may be configured to evaluate relevance by considering both complete and partial information that is useful for answering the query. The output is a ranking of document IDs in descending order of relevance, formatted as [doc1]>[doc2]>. . . , ensuring that the most relevant documents are prioritized. The order of documents going into the reader may be of critical importance which makes a good re-ranker one of the most crucial parts of the inference pipeline 424.

In some embodiments, at step S516, the process 500 implemented by the GPQRPM 406 may include synthesizing information relevant to answering question corresponding to the query from the re-ranked initial candidate chunks. In some embodiments, at S514 of the process 500, the LLM-based re-ranker may evaluate relevance by considering both complete and partial information that is useful for answering the query wherein each document is identified by an ID. In some embodiments, at S514, the process 500 may further include outputting a ranking of the document IDs in a descending order of relevance ensuring that the most relevant documents are prioritized for downstream applications.

In some embodiments, at step S518, the process 500 implemented by the GPQRPM 406 may include generating, by calling the answer generation module 430 included within the inference pipeline 424 via the sixth API, an answer corresponding to the query for consumption by downstream applications. Step S518 also includes displaying the answer onto the GUI 436.

For example, once the GPQRPM 406 have retrieved and curated the sources, the GPQRPM 406 my utilize the LLM based answer generation module 430 to synthesize information relevant to answering the question from the provided sources. This LLM based answer generation module 430 may be designed to enhance the accuracy, relevance, and safety of generated responses by leveraging a set of prompt guidelines derived from empirical experimentation. The LLM based answer generation module 430 may be built upon universal safety guide lines that ensure the generation of non-toxic and appropriate content as well as minimizing hallucinations and ensuring that the system refuses to answer when necessary, thereby maintaining the integrity of the information provided.

The LLM based answer generation module 430 (i.e., the reader or the answer generator)may be prompted to synthesize information across multiple sources and output citations which enhance the credibility and traceability of the information. The LLM based answer generation module 430 is the component which perhaps requires the most customization, allowing for tailored responses that align with specific use case needs, such as specifically synthesizing information and generating an answer which would be most relevant to a research analyst, product manager or a software engineer. However, key tenets such as safety and hallucination avoidance remain non-negotiable to ensure the reliability of the system. The customizability also extends to verbosity and formatting of information, such as short, focused answers or long form answers which cluster information in sources into topics and then generate a query conditioned summary.

In some embodiments, the LLM based answer generation module 430 may condition its answers on meta-data of documents, not just the content, providing additional context for answer generation and citation production. Finally, the chunks may be re-ordered in the LLM based answer generation module 430, such that reading order of chunks within the original documents may be preserved.

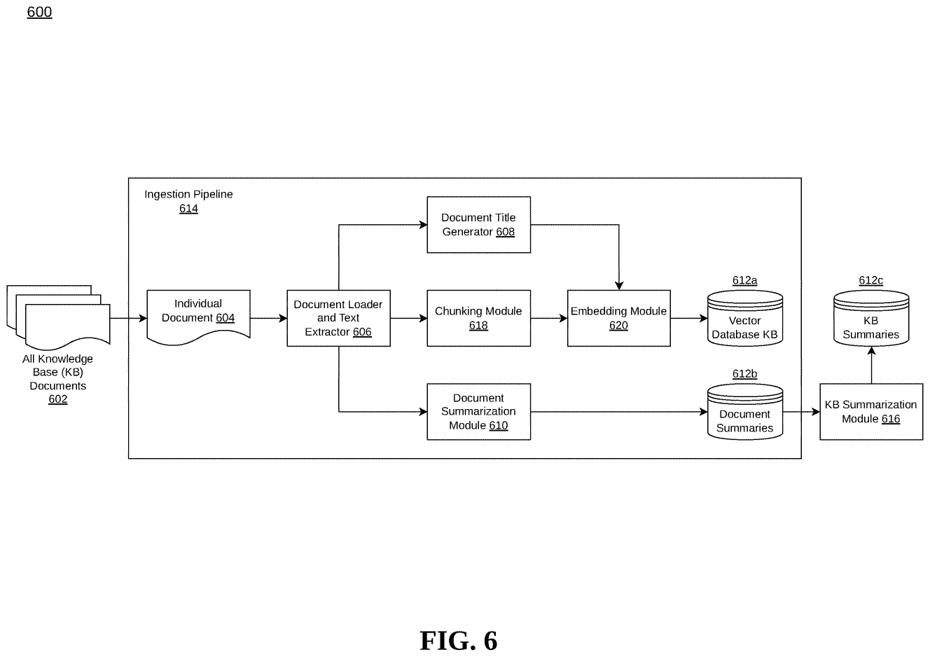

FIG. 6 illustrates an architecture 600 that includes more detailed components of an ingestion pipeline 614 (same or similar to the ingestion pipeline 414 as mentioned earlier with respect to FIG. 4) implemented by the platform, language, cloud, database, and domain agnostic GPQRPM 406 of FIG. 4 in accordance with an embodiment. The ingestion pipeline 614 as illustrated in FIG. 6 includes more detailed component architecture illustrating additional components of the ingestion pipeline 414 as illustrated in FIG. 4. As illustrated in FIG. 6, the ingestion pipeline 614 includes a document loader and text extractor 606 operatively connected with a document title generator 608, a chunking module 618 and a document summarization module 610; an embedding module 620, a vector database 612a for storing knowledge base (KB) and a document summaries database 612b.

As illustrated in FIG. 6, individual document 604 may be extracted from all KB documents 602 and input to the document loader and text extractor 606 which may output data to the document title generator 608, the document summarization module 610, and the chunking module 618. The embedding module 620 may receive data from both the document title generator 608 and the chunking module 620 and may output to the vector database for KB 612a. The document summarization module 610 may receive data from the document loader and text extractor 606 and may output documents summaries to the document summaries database 612b. As illustrated in FIG. 6, the KB summarization module 616 receives data from the document summaries database 612b and outputs to the KB summaries database 612c.

FIG. 7 illustrates an inference pipeline 700 (same or similar to the inference pipeline 424 as mentioned earlier with respect to FIG. 4) implemented by the platform, language, cloud, database, and domain agnostic GPQRPM 406 of FIG. 4 in accordance with an embodiment. The inference pipeline 700 as illustrated in FIG. 7 includes more detailed component architecture illustrating additional components of the inference pipeline 424 as illustrated in FIG. 4. As illustrated in FIG. 7, the inference pipeline 700 may include a query 701, a query re-writer 704, a Frequently Asked Question (FAQ) retriever 706, an FAQ routing 708 decision block, a conversation history database 712a, FAQ store 712b, a KB summaries database 712c, a document store 712d, decision block, an FAQ reader 710, a dense retrieval 720, a sparse retrieval 722, an LLM based ranker 728, a reciprocal rank fusion block 724, a hallucination detection block 726, a RAG reader 732, and display block for answer 734.

In some embodiments, as illustrated in the inference pipeline 700 of FIG. 7, user queries from the query 701 may be input to the query re-writer 704. The query re-writer 704 may rewrite the received queries based on the data received from the query 701, the conversation history database 712z, and the KB summaries 712c. The query re-writer 704 may then output data to the FAQ retriever 706. The FAQ retriever 706 may also receive data from the FAQ store 712b.

In some embodiments, at FAQ routing 708, data output from the FAQ retriever 706 may be routed to either unable to answer question path or able to answer question path. If at the FAQ routing 708, it is determined that the inference pipeline 700 may able to answer question, the FAQ reader 710 may output the answer 734 based on the data received from the FAQ retriever 706.

In some embodiments, if at the FAQ routing 708, it is determined that the inference pipeline 700 may not be able to answer question based on the data received from the FAQ retriever 706, RAG may be inputted to the document store 712d and may output the RAG to the dense retrieval 720 and the sparse retrieval 722. The reciprocal rank fusion block 724 may fuse both data received from the dense retrieval 720 and the sparse retrieval 722. The reciprocal rank fusion block 724 may then output data to the LLM based ranker 728. The LLM based ranker 728 may then output data (i.e., ranks) to the RAG reader 732 which may generate the answer 734. In some embodiments, the hallucination detection block 726 may detect whether there is any hallucination on the data output from the LLM based ranker 728. The inference pipeline 700 may then generate answer 734 after correcting the hallucination.

In some embodiments, the sparse retrieval 722 may implement a probabilistic term-weighting algorithm, such as BM25, to rank documents based on lexical similarity between a query and indexed document content. The algorithm computes relevance scores using term frequency, inverse document frequency, and document length normalization, thereby enabling efficient retrieval of documents containing exact or near-exact query terms. The sparse retrieval 722 may operate independently or in combination with a dense retrieval 720 as part of a hybrid retrieval architecture.

In some embodiments, the inference pipeline 700 may support multiple relevance evaluation and re-ranking strategies for ordering retrieved documents in response to a query.

In a first approach, a language-model-based pointwise relevance evaluation is employed. In this configuration, a language model, i.e., LLM 407, may be provided with a query and a single retrieved document, and may generate a relevance score or relevance classification for the document with respect to the query. Each query-document pair may be evaluated independently, enabling parallel execution across multiple documents. This approach avoids exceeding model context length limitations, as each inference involves a limited input size.

In a second approach, a listwise or permutation-based re-ranking strategy may be employed. In this configuration, a language model, i.e., the LLM 407 may be provided with a query and a plurality of retrieved documents within a single inference call, and may generate a ranked ordering or relative relevance assessment across the document set. This approach enables the language model to consider global context and inter-document relationships, potentially improving ranking quality.

In a third approach, a neural cross-encoder-based relevance model may be employed. In this configuration, a query and a retrieved document may be jointly encoded to produce a relevance score. The execution flow is similar to pointwise relevance evaluation, with each query-document pair processed independently. Such models may require specialized hardware acceleration, such as graphics processing units, to achieve scalable performance in production environments. In some embodiments, the cross-encoder relevance model may be fine-tuned using domain-specific training data to improve ranking accuracy.

The dataset utilized by the inference pipeline 700 may be configured to evaluate a default RAG pipeline for financial and enterprise computing environments using a reference-based evaluation framework. In some embodiments, the dataset may include a plurality of query-answer pairs derived from real user interactions with financial, regulatory, or enterprise information systems. For each query, one or more reference materials, such as authoritative documents, passages, or records from a financial knowledge base, may be identified and associated with the query to serve as grounding evidence for evaluation. However, the disclosure is not limited thereto.

In some embodiments, evaluation of the RAG pipeline may be performed using the LLM 407 (see, FIG. 4) operating as an automated judge. The LLM-as-judge may be provided with (i) a user query, (ii) a response generated by the RAG pipeline, and (iii) corresponding reference information retrieved from one or more knowledge bases. The LLM-as-judge may be configured to assess the generated response relative to the reference information and to produce one or more evaluation outputs, such as correctness scores, faithfulness indicators, completeness measures, or explanatory rationales.

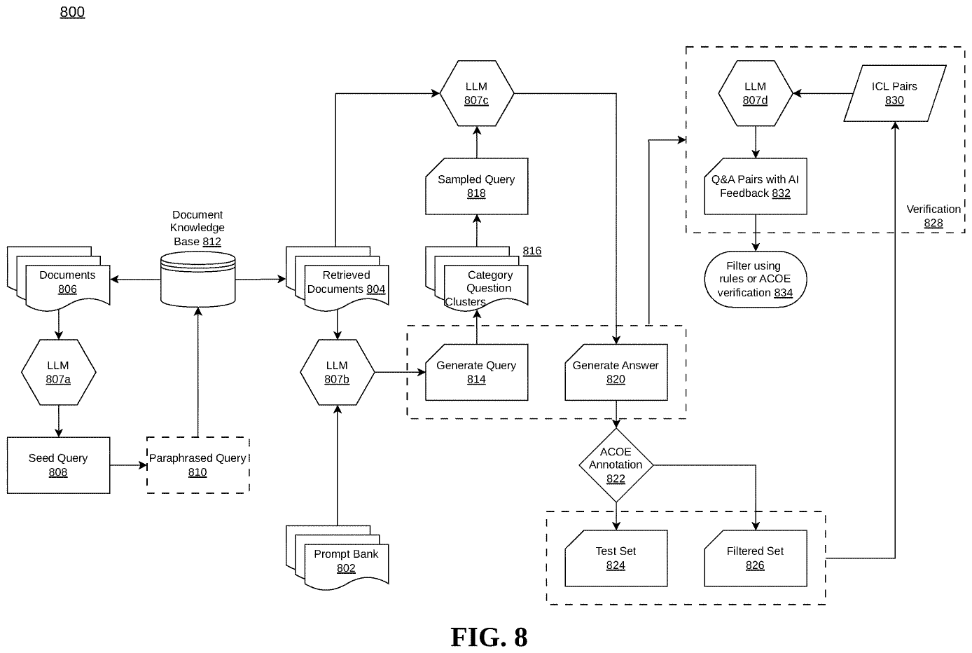

In some embodiments, the dataset may further include synthetically generated queries, expert-curated questions, or combinations thereof (see, e.g., FIG. 8 as described below), each paired with reference materials suitable for reference-based evaluation. The dataset may be used to evaluate individual components of the RAG pipeline, including retrieval, re-ranking, and answer generation modules, as well as end-to-end system performance. By grounding evaluation in reference materials and employing an automated LLM-based judge, the disclosed approach may provide a scalable and reliable mechanism for assessing RAG system quality, particularly for long-form or complex financial queries.

FIG. 8 illustrates a synthetic dataset generation pipeline 800 implemented by the platform, language, cloud, database, and domain agnostic GPQRPM 406 of FIG. 4 in accordance with an embodiment. As mentioned earlier, in many enterprise deployments, including financial and regulated environments, newly developed RAG systems may be frequently introduced as greenfield implementations. In such scenarios, domain-specific document corpora are typically available, while historical user interaction data, such as real user queries or feedback signals, is limited or absent. As a result, conventional approaches that rely on logged user queries, relevance judgments, or preference data are often impractical or infeasible at system initialization.

In certain cases, limited feedback data may be available, such as associations between queries and retrieved documents, which may be used to evaluate retrieval or re-ranking performance, or user-indicated preferred responses, which may be used to assess answer generation quality. However, such feedback data is generally sparse, delayed, or incomplete, particularly during early-stage deployment.

To support immediate system validation and optimization under these constraints, the synthetic dataset generation pipeline 800 may provide for the generation and use of evaluation datasets suitable for benchmarking end-to-end RAG pipelines. In particular, the evaluation datasets may include synthetically generated queries that are designed to approximate natural human questioning behavior. Unlike conventional question generation models that condition on individual documents and produce narrowly scoped, document-specific questions, the disclosed approach generates queries that are more general, multi-faceted, and potentially ambiguous, reflecting how users typically formulate information-seeking queries in real-world enterprise settings.

The generated evaluation datasets may be used to assess the performance of multiple components of a RAG pipeline, including retrieval modules, re-ranking modules, and answer generation modules, both individually and in combination as disclosed herein. In addition, the generated datasets may serve as training data for fine-tuning one or more components of the RAG system, including retrievers, re-rankers, and answer generators, prior to or during production deployment.

By enabling realistic evaluation and training in the absence of extensive user interaction data, the disclosed techniques improve system readiness, robustness, and performance in greenfield enterprise deployments.

As illustrated in the synthetic dataset generation pipeline 800, a document KB 812 may store all KB. A seed query 808 may receive data from the LLM 807a which may receive the documents 806 from the document KB 812. There is a paraphrased query 810 block which may paraphrase the query received from the seed query 808 may send the data to the document KB 812. The LLM 807b may receive retrieved documents 804 and data corresponding to prompt bank 802. The LLM 807b may generate query 814 which may be utilized to generate category question clusters 816, and then sample query 818 which may be input to the LLM 807c. The LLM 807c may generate answer 820. The answer may be sent for verification 828.

Described herein are systems and methods for automated ontology engineering using LLMs, i.e., LLMs 807a, 807b, 807c, 807d. In certain embodiments, an automated collaborative ontology engineering (ACOE) framework may be implemented by the GPQRPM 406 of FIG. 4 may be provided in which multiple LLM-powered agents cooperatively generate, refine, and validate domain ontologies. The framework may be configured to reduce the time, computational resources, and human effort required to construct domain-specific ontologies, including complex enterprise and industry-specific knowledge representations.

In some embodiments, the framework may employ an RAG architecture in which external data sources are retrieved and incorporated into the ontology generation process to improve factual accuracy and domain relevance. Retrieved information may include unstructured text data and meta-data associated with it. The retrieved data may be used to ground ontology concepts, relationships, and constraints, thereby mitigating hallucinations and incomplete representations produced by standalone language models.

The disclosed system further includes a plurality of LLM-powered agents, each configured to simulate a distinct role within an ontology engineering workflow. Such roles may include, without limitation, concept extraction, relationship definition, schema validation, consistency checking, and domain expert review. The agents interact through a coordinated execution framework to iteratively propose, evaluate, and refine ontology elements.

In certain implementations, the framework may be model-agnostic and supports multiple LLM backends, i.e., LLMs 807a, 807b, 807c, 807d. The system may be implemented using an orchestration layer that manages agent interactions, retrieval operations, and generation tasks.

To address known limitations of LLM-based ontology construction, including hallucinations, logical inconsistencies, and outdated knowledge, the framework optionally includes validation and evaluation mechanisms. These mechanisms may assess generated ontology elements against retrieved reference data, predefined constraints, or quality metrics, thereby improving reliability and correctness of the resulting ontologies.

For example, in some embodiments, at ACOE annotation 822, data may flow to a first pate to generate test set 824 and a second path to generate filtered set 826. Both the test set 824 and the filtered set 826 by flow to ICL pairs 830. Data from the ICL pairs 830 may flow to LLM 807d for generating QA pairs with Artificial Intelligence (AI) feedback 832 and then filter using rules or ACOE verification at block 834.

In some embodiments, the GPQRPD 402 may include a memory (e.g., a memory 106 as illustrated in FIG. 1 which may be a non-transitory computer readable medium that may be configured to store instructions for implementing a platform, language, cloud, database, and domain agnostic GPQRPM 406 for automatically question answering on documents across various domains as disclosed herein. The GPQRPD 402 may also include a medium reader (e.g., a medium reader 112 as illustrated in FIG. 1) which may be configured to read any one or more sets of instructions, e.g., software, from any of the memories described herein. The instructions, when executed by a processor embedded within the GPQRPM 406 or within the GPQRPD 402, may be used to perform one or more of the processes as described herein. In a particular embodiment, the instructions may reside completely, or at least partially, within the memory 106, the medium reader 112, and/or the processor 104 (see FIG. 1) during execution by the GPQRPD 402.

In some embodiments, the instructions, when executed, may cause a processor embedded within the GPQRPM 406 or the GPQRPD 402 to perform the following: i) establishing a communication link between a plurality of document sources having various domains and the general-purpose QA pipeline via a communication network, wherein the general-purpose QA pipeline includes an ingestion pipeline and an inference pipeline; ii) receiving, by a receiving module included within the ingestion pipeline, a document among a set of plurality of documents received from the plurality of document sources; iii) chunking, by a chunking module included within the ingestion pipeline, the document into a plurality of chunks each including relatively smaller, semantically meaningful segment to address context length limitations; iv) embedding, by an embedding module included within the ingestion pipeline, the plurality of chunks; v) storing the embedded plurality of chunks into a vector database; repeating steps ii)-v) for all documents among the set of plurality of documents thereby creating a knowledge base; executing the inference pipeline that, given a query, retrieves, by a hybrid retriever module included within the inference pipeline, documents from the knowledge base that are relevant to the query by utilizing weighted combination of sparse and dense retrieval; implementing an LLM-based re-ranker module included within the inference pipeline to re-rank initial candidate chunks from the hybrid retriever module; implementing an LLM-based answer generation module included within the inference pipeline to synthesize information relevant to answering question corresponding to the query from the re-ranked initial candidate chunks; and generating an answer corresponding to the query for consumption by downstream applications. In some embodiments, the processor may be the same or similar to the processor 104 as illustrated in FIG. 1 or the processor embedded within the AIDFERD 202, AIDFERD 302, AIDFERD 402, and AIDFERM 406 which may be the same or similar to the processor 104.

In some embodiments, in receiving the first document, the instructions, when executed, may cause the processor 104 to further perform the following: parsing the set of plurality of documents received from the plurality of document sources, wherein the documents having different file formats.

In some embodiments according to the non-transitory computer readable medium, the different file formats may include one or more of the following file formats: PDF, .doc, .docx, html, and .txt, but the disclosure is not limited thereto.

In some embodiments, in chunking the first document into a plurality of chunks, the instructions, when executed, may cause the processor 104 to further perform the following: implementing an LLM to generate a relevant context for each chunk among the plurality of chunks.

In some embodiments according to the non-transitory computer readable medium, the vector database may support both the sparse and the dense retrieval.

In some embodiments according to the non-transitory computer readable medium, the LLM-based re-ranker module may evaluate relevance by considering both complete and partial information that is useful for answering the query wherein each document is identified by an ID.

In some embodiments, the instructions, when executed, may cause the processor 104 to further perform the following: outputting a ranking of the document IDs in a descending order of relevance ensuring that the most relevant documents are prioritized for downstream applications.

In some embodiments as disclosed above in FIGS. 1-8, technical improvements effected by the instant disclosure may include a platform for implementing a platform, language, cloud, database, and domain agnostic general-purpose query-response pipeline module configured for automatic question answering on documents across various domains, thereby enhancing reliability and accuracy, reducing implementation complexity, and supporting deployment across diverse enterprise computing environments, including financial institutions, corporate reporting systems, and other regulated or high-assurance domains, but the disclosure is not limited thereto.

Although the invention has been described with reference to several exemplary embodiments, it is understood that the words that have been used may be words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, method, and uses such as are within the scope of the appended claims.

In some embodiments, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards may be periodically superseded by faster or more efficient equivalents having essentially the same functions. Accordingly, replacement standards and protocols having the same or similar functions may be considered equivalents thereof.

The illustrations of the embodiments described herein are intended to provide a general understanding of the various embodiments. The illustrations are not intended to serve as a complete description of all of the elements and features of apparatus and systems that utilize the structures or method described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it may not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for implementing a general-purpose question answering (QA) pipeline for question answering on documents across various domains by utilizing one or more processors along with allocated memory, the method comprising:
i) establishing a communication link between a plurality of document sources having various domains and the general-purpose QA pipeline via a communication network, wherein the general-purpose QA pipeline includes an ingestion pipeline and an inference pipeline;
ii) receiving, by a receiving module included within the ingestion pipeline, a document among a set of plurality of documents received from the plurality of document sources;
iii) chunking, by a chunking module included within the ingestion pipeline, the document into a plurality of chunks each including relatively smaller, semantically meaningful segment to address context length limitations;
iv) embedding, by an embedding module included within the ingestion pipeline, the plurality of chunks;
v) storing the embedded plurality of chunks into a vector database;
repeating steps ii)-v) for all documents among the set of plurality of documents thereby creating a knowledge base;
executing the inference pipeline that, given a query, retrieves, by a hybrid retriever module included within the inference pipeline, documents from the knowledge base that are relevant to the query by utilizing weighted combination of sparse and dense retrieval;
implementing a large language model (LLM)-based re-ranker module included within the inference pipeline to re-rank initial candidate chunks from the hybrid retriever module;
implementing an LLM-based answer generation module included within the inference pipeline to synthesize information relevant to answering question corresponding to the query from the re-ranked initial candidate chunks; and
generating an answer corresponding to the query for consumption by downstream applications.

2. The method according to claim 1, wherein in receiving a first document, the method further comprising:
parsing the set of plurality of documents received from the plurality of document sources, wherein the documents having different file formats.

3. The method according to claim 2, wherein the different file formats include one or more of the following file formats: PDF, .doc, .docx, html, and .txt.

4. The method according to claim 1, wherein in chunking the first document into a plurality of chunks, the method further comprising:
implementing an LLM to generate a relevant context for each chunk among the plurality of chunks.

5. The method according to claim 1, wherein the vector database supports both the sparse and the dense retrieval.

6. The method according to claim 1, wherein the LLM-based re-ranker module evaluates relevance by considering both complete and partial information that is useful for answering the query wherein each document is identified by a unique identifier (ID).

7. The method according to claim 6, further comprising:
outputting a ranking of the document IDs in a descending order of relevance ensuring that the most relevant documents are prioritized for downstream applications.

8. A system for implementing a general-purpose question answering (QA) pipeline for question answering on documents across various domains, the system comprising:
a processor; and
a memory operatively connected to the processor via a communication interface, the memory storing computer readable instructions, when executed, causes the processor to:
i) establish a communication link between a plurality of document sources having various domains and the general-purpose QA pipeline via communication interface, wherein the general-purpose QA pipeline includes an ingestion pipeline and an inference pipeline;
ii) receive, via a receiving module included within the ingestion pipeline, a document among a set of plurality of documents received from the plurality of document sources;
iii) chunk, via a chunking module included within the ingestion pipeline, the document into a plurality of chunks each including relatively smaller, semantically meaningful segment to address context length limitations;
iv) embed, via an embedding module included within the ingestion pipeline, the plurality of chunks;
v) store the embedded plurality of chunks into a vector database;
repeat steps ii)-v) for all documents among the set of plurality of documents thereby creating a knowledge base;
execute the inference pipeline that, given a query, retrieves, by a hybrid retriever module included within the inference pipeline, documents from the knowledge base that are relevant to the query by utilizing weighted combination of sparse and dense retrieval;
implement a large language model (LLM)-based re-ranker module included within the inference pipeline to re-rank initial candidate chunks from the hybrid retriever module;
implement an LLM-based answer generation module included within the inference pipeline to synthesize information relevant to answering question corresponding to the query from the re-ranked initial candidate chunks; and
generate an answer corresponding to the query for consumption by downstream applications.

9. The system according to claim 8, wherein in receiving the document, the processor is further configured to:
parse the set of plurality of documents received from the plurality of document sources, wherein the documents having different file formats.

10. The system according to claim 9, wherein the different file formats include one or more of the following file formats: PDF, .doc, .docx, html, and .txt.

11. The system according to claim 8, wherein in chunking the document into a plurality of chunks, the processor is further configured to:
implement an LLM to generate a relevant context for each chunk among the plurality of chunks.

12. The system according to claim 8, wherein the vector database supports both the sparse and the dense retrieval.

13. The system according to claim 8, wherein the LLM-based re-ranker module evaluates relevance by considering both complete and partial information that is useful for answering the query wherein each document is identified by a unique identifier (ID).

14. The system according to claim 13, wherein the processor is further configured to:
output a ranking of the document IDs in a descending order of relevance ensuring that the most relevant documents are prioritized for downstream applications.

15. A non-transitory computer readable medium configured to store instructions for implementing a general-purpose question answering (QA) pipeline for question answering on documents across various domains, the instructions, when executed, cause a processor to perform the following:
i) establishing a communication link between a plurality of document sources having various domains and the general-purpose QA pipeline via a communication network, wherein the general-purpose QA pipeline includes an ingestion pipeline and an inference pipeline;
ii) receiving, by a receiving module included within the ingestion pipeline, a document among a set of plurality of documents received from the plurality of document sources;
iii) chunking, by a chunking module included within the ingestion pipeline, the document into a plurality of chunks each including relatively smaller, semantically meaningful segment to address context length limitations;
iv) embedding, by an embedding module included within the ingestion pipeline, the plurality of chunks;
v) storing the embedded plurality of chunks into a vector database;
repeating steps ii)-v) for all documents among the set of plurality of documents thereby creating a knowledge base;
executing the inference pipeline that, given a query, retrieves, by a hybrid retriever module included within the inference pipeline, documents from the knowledge base that are relevant to the query by utilizing weighted combination of sparse and dense retrieval;
implementing a large language model (LLM)-based re-ranker module included within the inference pipeline to re-rank initial candidate chunks from the hybrid retriever module;
implementing an LLM-based answer generation module included within the inference pipeline to synthesize information relevant to answering question corresponding to the query from the re-ranked initial candidate chunks; and
generating an answer corresponding to the query for consumption by downstream applications.

16. The non-transitory computer readable medium according to claim 15, wherein in receiving the document, the instructions, when executed, cause the processor to further perform the following:
parsing the set of plurality of documents received from the plurality of document sources, wherein the documents having different file formats.

17. The non-transitory computer readable medium according to claim 16, wherein the different file formats include one or more of the following file formats: PDF, .doc, .docx, html, and .txt.

18. The non-transitory computer readable medium according to claim 16, wherein in chunking the document into a plurality of chunks, the instructions, when executed, cause the processor to further perform the following:
implementing an LLM to generate a relevant context for each chunk among the plurality of chunks.

19. The non-transitory computer readable medium according to claim 15, wherein the vector database supports both the sparse and the dense retrieval.

20. The non-transitory computer readable medium according to claim 15, wherein the LLM-based re-ranker module evaluates relevance by considering both complete and partial information that is useful for answering the query wherein each document is identified by a unique identifier (ID), and wherein the instructions, when executed, cause the processor to further perform the following:
outputting a ranking of the document IDs in a descending order of relevance ensuring that the most relevant documents are prioritized for downstream applications.
